(19) United States
(12) Patent Application Publication
(10) Pub. No.: US 2017/0333845 A1
(43) Pub. Date: Nov. 23, 2017

(54) APPARATUS AND METHOD FOR RECOVERING ACID

(71) Applicant: General Electric Company, Schenectady, NY (US)

(72) Inventors: Chengqian ZHANG, Shanghai (CN); Rihua XIONG, Shanghai (CN); Hai YANG, Shanghai (CN); John H. BARBER, Guelph (CA); Yongdi ZHANG, Shanghai (CN); Wei LU, Shanghai (CN)

(21) Appl. No.: 15/532,512

(22) PCT Filed: Jan. 6, 2016
(86) PCT No.: PCT/US2016/012302

§ 371 Date: Jun. 2, 2017

(30) Foreign Application Priority Data
Jan. 7, 2015 (CN) 201510006798.5

(51) Int. Cl. B01D 61/46; B01D 69/12; B01D 53/22

(52) U.S. Cl. CPC B01D 61/46; B01D 69/12; B01D 53/228

(57) ABSTRACT

An apparatus for recovering acid includes: a cathode; an anode; a plurality of anion exchange membranes disposed between the cathode and the anode; a plurality of proton selective membranes alternately arranged with the plurality of anion exchange membranes; a plurality of first compartments for accommodating an aqueous stream comprising anions and protons; and a plurality of second compartments alternately arranged with the plurality of first compartments for accommodating a recovery stream receiving from the first compartments anions through the anion exchange membranes and mainly protons through the proton selective membranes. An associated method is also described.

### BACKGROUND

This invention relates generally to apparatuses and methods for recovering acid.

Currently available apparatuses and methods are not satisfactory in one way or another to recover acids from aqueous streams, such as the waste aqueous streams produced from using acids to remove oxides and other impurities from surfaces of metals.

Therefore, there is a need for new apparatuses and methods for recovering acid.

### BRIEF DESCRIPTION

In one aspect, embodiments of the present invention relate to an apparatus for recovering acid, comprising: a cathode; an anode; a plurality of anion exchange membranes disposed between the cathode and the anode; a plurality of proton selective membranes alternately arranged with the plurality of anion exchange membranes; a plurality of first compartments for accommodating an aqueous stream comprising anions and protons; and a plurality of second compartments alternately arranged with the plurality of first compartments for accommodating a recovery stream receiving from the first compartments anions through the anion exchange membranes and mainly protons through the proton selective membranes.

In another aspect, embodiments of the present invention relate to a method for recovering acid, comprising: inputting an aqueous stream comprising anions and protons into an apparatus, the apparatus comprising a cathode, an anode, a plurality of anion exchange membranes disposed between the cathode and the anode, a plurality of proton selective membranes alternately arranged with the plurality of anion exchange membranes, a plurality of first compartments for receiving the aqueous stream, and a plurality of second compartments alternately arranged with the plurality of first compartments; and applying a voltage to the cathode and the anode to migrate from the first compartments the anions through the anion exchange membranes and protons through the proton selective membranes to a recovery stream in the second compartments.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 illustrates a schematic diagram of an apparatus in accordance with embodiments of the invention;

FIG. 2 shows the voltage-current curves with respect to the test time of the comparative example; and

FIG. 3 shows the voltage-current curves with respect to the test time of example 2.

### DETAILED DESCRIPTION OF THE DISCLOSURE

Unless defined otherwise, technical and scientific terms used herein have the same meaning as is commonly understood by one of ordinary skill in the art to which this disclosure belongs. The use of “including”, “comprising” or “having” and variations thereof herein are meant to encompass the items listed thereafter and equivalents thereof as well as additional items.

Approximating language, as used herein throughout the specification and claims, may be applied to modify any quantitative representation that could permissibly vary without resulting in a change in the basic function to which it is related. Accordingly, a value modified by a term or terms, such as “about” is not to be limited to the precise value specified. In some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

In the following specification and claims, the singular forms “a”, “an” and “the” include plural referents, unless the context clearly dictates otherwise. Moreover, the suffix “(s)” as used herein is usually intended to include both the singular and the plural of the term that it modifies, thereby including one or more of that term. The terms “first,” “second,” and the like, herein do not denote any order, quantity, or importance, but rather are used to, such as, distinguish one element from another or one embodiment from another.

As used herein, the term “or” is not meant to be exclusive and refers to at least one of the referenced components (for example, a material) being present and includes instances in which a combination of the referenced components may be present, unless the context clearly dictates otherwise.

Reference throughout the specification to “some embodiments”, and so forth, means that a particular element (e.g., feature, structure, and/or characteristic) described in connection with the invention is included in at least one embodiment described herein, and may or may not be present in other embodiments. In addition, it is to be understood that the described inventive features may be combined in any suitable manner in the various embodiments.

Preferred embodiments of the present disclosure will be described hereinbelow with reference to the accompanying drawings. In the following description, well-known functions or constructions are not described in detail to avoid obscuring the disclosure in unnecessary detail.

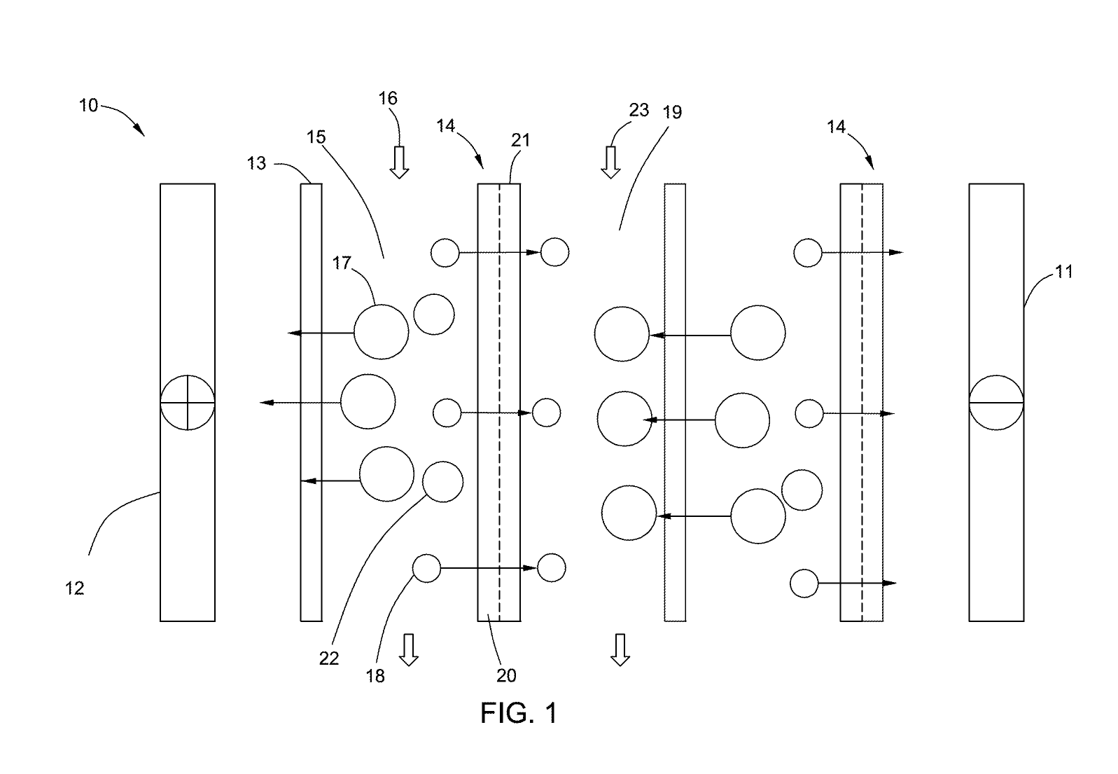

FIG. 1 illustrates a schematic diagram of an apparatus 10 for recovering acid in accordance with embodiments of the invention. The apparatus 10 includes: a cathode 11; an anode 12; a plurality of anion exchange membranes 13 disposed between the cathode 11 and the anode 12; a plurality of proton selective membranes 14 alternately arranged with the plurality of anion exchange membranes 13; a plurality of first compartments 15 for accommodating an aqueous stream 16 comprising anions 17 and protons 18; and a plurality of second compartments 19 alternately arranged with the plurality of first compartments 15 for accommodating a recovery stream 23 receiving from the first compartments 15 the anions 17 through the anion exchange membranes 13 and protons 18 through the proton selective membranes 14.

In some embodiments, each first compartment 15 together with one adjacent second compartment 19 defines a repeating unit, or a compartment pair. An apparatus 10 may comprise any number of compartment pairs based on the treatment requirement of the aqueous stream 16 or the stack design of the apparatus 10.

As used herein, the term “acid” or the like refers to a chemical substance or a combination of chemical substances whose aqueous solutions are able to turn blue litmus red, and to react with bases and certain metals (like calcium) to form salts. Aqueous solutions of acids have a pH of less than 7. A lower pH indicates a higher acidity, and a higher concentration of positive hydrogen ions (protons) in the aqueous solution. Examples of acids include, but are not limited to, hydrogen chloride, hydrogen fluoride, acetic acid, sulfuric acid, nitric acid, carbonic acid, boric acid, phosphoric acid, tartaric acid, and any combination thereof.

The cathode 11 may comprise any electrically conductive material suitable for use in cathodes. Examples of materials for the cathode 11 include, but are not limited to, nickel, platinum, platinized titanium, steel such as stainless steel, and any combination thereof.

The anode 12 may comprise any electrically conductive material suitable for use in anodes. Examples of materials for the anode 12 include, but are not limited to, titanium, platinum, platinized titanium, carbons such as graphite and lead dioxide, palladium, iridium, gold, ruthenium, tantalum, and any combination thereof.

The anion exchange membrane 13 may be any membrane that enables the selective passage of anions. Examples of the anion exchange membrane include, but are not limited to, a 204-UZL-386 anion membrane and an AR204 SXZL anion exchange membrane both available from Ionics, Incorporated, Watertown, Mass., USA, a Neosepta AMX-SB anion exchange membrane and a Neosepta AXE-01 anion membranes both available from Tokuyama Soda Co., Ltd., Tokyo, Japan, a DF43 anion exchange membrane of Toyo Soda Manufacturing Co., Yamaguchi, Japan, a Selemion® AMV, ASV or AAV anion permselective membrane sold by Asahi Glass Co., Ltd., Tokyo, Japan, an aliphatic quaternary ammonium anion exchange membrane described in U.S. Pat. No. 4,231,855, and an anion exchange membrane prepared by treating a styrene/butadiene/divinylbenzene copolymer with dichloroethane and subsequently with triethylamine,

The proton selective membrane 14 may be any membrane that enables the selective passage of protons. As used herein, the term “proton selective” refers to a situation in which among all ions passing through the proton selective membrane 14 the amount of protons is more than that of other ions, if any. In some embodiments, only protons pass the proton selective membrane 14. In some embodiments, the level of cations (other than protons) entering the second compartments 19 through the proton selective membrane 14 is less than about 50 wt %, about 30 wt %, or about 10 wt % of the cations (other than protons) originally in the first compartments 15.

In some embodiments, the proton selective membrane 14 comprises an anion exchange membrane element 20 and a cation exchange membrane element 21 attached to the anion exchange membrane element 20. The proton selective membrane 14 may be placed in the apparatus 10 in a preferred orientation that the anion exchange membrane element 20 faces the anode 12 while the cation exchange membrane element 21 faces the cathode 11. This preferred orientation helps to reduce/eliminate the scaling of the proton selective membrane 14. The anion exchange membrane element 20 may be any anion exchange membrane that is the same as or different from the anion exchange membrane 13.

The cation exchange membrane element 21 may be any membrane that enables the selective passage of cations. Examples of the cation exchange membrane include, but are not limited to, CR61-AZL or CR67 AZL cation exchange membranes available from Ionics, Incorporated, Watertown, Mass., USA, a Neosepta CMB cation exchange membrane and a Neosepta CMX-SB cation membrane both available from Tokuyama Soda Co., Ltd., Tokyo, Japan, Nafion® acidic flourocarbon membranes, e.g. Nafion® 110, 901, and 324 cation membranes of DuPont Company, Wilmington, Del., USA, and cation exchange membranes prepared by sulfonating a styrene/butadiene/divinylbenzene copolymer with sulfuric anhydride.

In some embodiments, the proton selective membrane 14 has a layer of anion exchange material 20 and a layer of cation exchange material 21 integrated with the layer of anion exchange material 20 in way of, e.g., painting, coating, dipping, spraying, rolling and brushing. The proton selective membrane 14 may be placed in the apparatus 10 in a preferred orientation that the layer of anion exchange material 20 faces the anode 12 while the layer of cation exchange material 21 faces the cathode 11. This preferred orientation helps to reduce/eliminate the scaling of the proton selective membrane 14.

The layer of anion exchange material 20 may comprise any material for making any anion exchange membrane as described above. The cation exchange material 21 may comprise any material for making any cation exchange membrane as described above.

The first compartments 15 and the second compartments 19 are arranged alternately with each other and between the cathode 11, the anion exchange membranes 13, the proton selective membranes 14 and the anode 12.

The aqueous stream 16 accommodated in the first compartments 15 may be any aqueous stream including anions 17 and protons 18. In some embodiments, the aqueous stream 16 has cations 22 other than protons.

When a voltage is applied to the cathode 11 and the anode 12, the anions 17 migrate toward the anode 12 through the anion exchange membranes 13 into the second compartments 19, the protons 18 migrate toward the cathode 11 through the proton selective membranes 14 into the second compartments 19, while most of the cations 22 other than protons, if any, are blocked by the proton selective membranes 14 and stayed in the first compartments while migrating toward the cathode 11.

The voltage may be of any strength to cause the migration of ions without splitting water into hydroxide ions and protons. In some embodiments, the voltage is from about 0.5 Volt to about 3.0 Volt of direct current (DC) voltage for each compartment pair. The application of the voltage may be at any suitable temperature and pressure, e.g., the room temperature and the atmospheric pressure.

In some embodiments, the recovery stream 23 is provided to the second compartments 19 before the voltage is applied. The recovery stream 23 may be any aqueous stream for recovering acid from the aqueous stream 16. In some embodiments, the recovery stream 23 comprises an aqueous solution of acid, e.g. the acid to be recovered from the aqueous stream 16.

In some embodiments, the aqueous stream 16 flows once through the first compartments 15. In some embodiments, the aqueous stream 16 is recirculated through the first compartments 15. In some embodiments, the recovery steam 23 flows once through the second compartments 19. In some embodiments, the recovery stream 23 is recirculated through the second compartments 19.

By adjusting the ratio of the flow rate of the recovery stream 23 to that of the aqueous stream 16 or using a proper recirculation process, the concentration of the acid recovered from the aqueous stream 16 to the recovery stream 23 and/or an acid recovery ratio (the ratio of the final amount of acid in the recovery stream to the initial amount of acid in the aqueous stream) may be improved.

In some embodiments, a final acid concentration in the recovery stream 23 may be adjusted to be from about 2 times to about 20 times of an initial acid concentration of the aqueous stream 16 for the purpose of recovering and concentrating the acid. In some embodiments, the acid recovery ratio may be from about 50% to about 90%.

### EXAMPLES

The following examples are included to provide additional guidance to those of ordinary skill in the art in practicing the claimed invention. These examples do not limit the invention as defined in the appended claims.

### Example 1

A CR67 AZL cation exchange membrane and an AR204 SXZL anion exchange membrane, both available from Ionics, Incorporated, Watertown, Mass., U.S.A., were attached to each other to integrally form a proton selective membrane.

An apparatus was built using a titanium plate as the anode and a stainless steel plate as the cathode and alternately arranging the AR204 SXZL anion exchange membranes and the proton selective membranes between the anode and the cathode to define 5 compartments pairs (5 first compartments and 5 second compartments alternately arranged with the first compartments). The length and width of the anode, the cathode and each of the cation exchange membranes and the anion exchange membranes were respectively 10 inches and 9 inches.

### Comparative Example

An aqueous stream of about 40 liters was prepared and comprised about 10,000 ppm sodium chloride. A recovery stream of about 2 liters was prepared and comprised about 10,000 ppm sodium chloride.

A constant DC voltage of 10 Volt was applied to the cathode and the anode while the aqueous stream was recirculated through the first compartments and the recovery stream was recirculated through the second compartments both at a flow rate of 0.5 l/min.

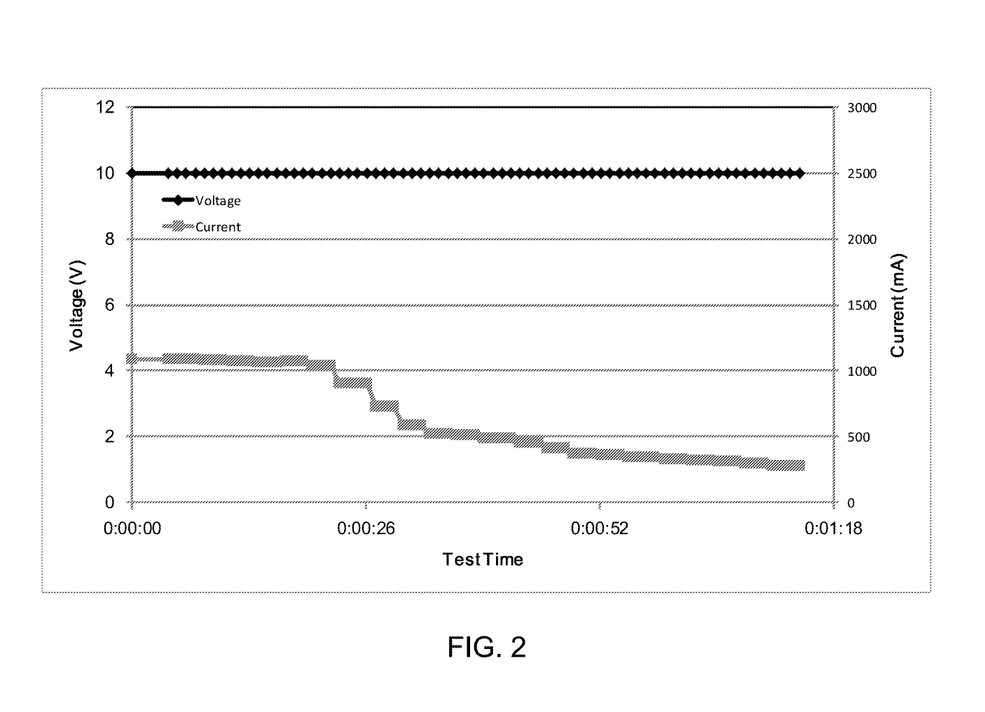

The voltage-current curves with respect to the test time are shown in FIG. 2. The quick drop shown in FIG. 2 of the electrical current from about 1,000 mA to about 300 mA in about 1 minute suggests that most cations other than protons were blocked by the proton selective membranes, water was not split into protons and hydroxide ions, and the apparatus does not work for streams not comprising acid.

### Example 2

An aqueous stream of about 40 liters was prepared and comprised about 0.15% hydrogen chloride, about 5,000 ppm calcium chloride and about 5,000 ppm sodium chloride. A recovery stream of about 2 liters was prepared and comprised about 0.19% hydrogen chloride. The pH of the aqueous stream and the recovery stream were both about 1.4.

A constant DC voltage of 10 Volt was applied to the cathode and the anode while the aqueous stream was recirculated through the first compartments and the recovery stream was recirculated through the second compartments both at a flow rate of 0.51/min.

The concentration of hydrogen chloride was determined by titration with sodium hydroxide. The concentrations of other ionic species were measured using an inductive coupled plasma emission spectrometer and added up to be the concentration of impurities. The concentrations of hydrogen chloride and impurities in the aqueous stream and the recovery stream before and after about 4 hours of recirculation are listed in table 1 below.

TABLE 1

| | concentra- | concentra- | | |
|---|---|---|---|---|
| | tion | tion | concentra- | concentra- |
| | of hydrogen | of hydrogen | tion | tion |
| | chloride | chloride | of impurities | of impurities |
| | before | after | before | after |
| stream | recirculation | recirculation | recirculation | recirculation |
| aqueous | 0.15 wt % | 0.03 wt % | 0.82 wt % | 0.82 wt % |
| recovery | 0.19 wt % | 1.97 wt % | 0 | 0.06 wt % |

The data in table 1 indicate that from the first compartments protons migrated through the proton selective membranes and chloride ions migrated through the anion exchange membranes both to the second compartments, while most of the calcium ions and sodium ions were kept in the first compartments. Therefore, hydrogen chloride was selectively recovered from the first compartments and concentrated in the second compartments.

The acid recovery ratio was calculated with the following formula: the weight of acid in the recovery stream after 4 hours of recirculation/the weight of acid in the aqueous stream before 4 hours of recirculation×100% to be 77.6% and the purity of recovered acid was calculated with the following formula: the weight of acid in the recovery stream after 4 hours of recirculation/the weight of the recovery stream after 4 hours of recirculation×100% to be 97.2 wt %.

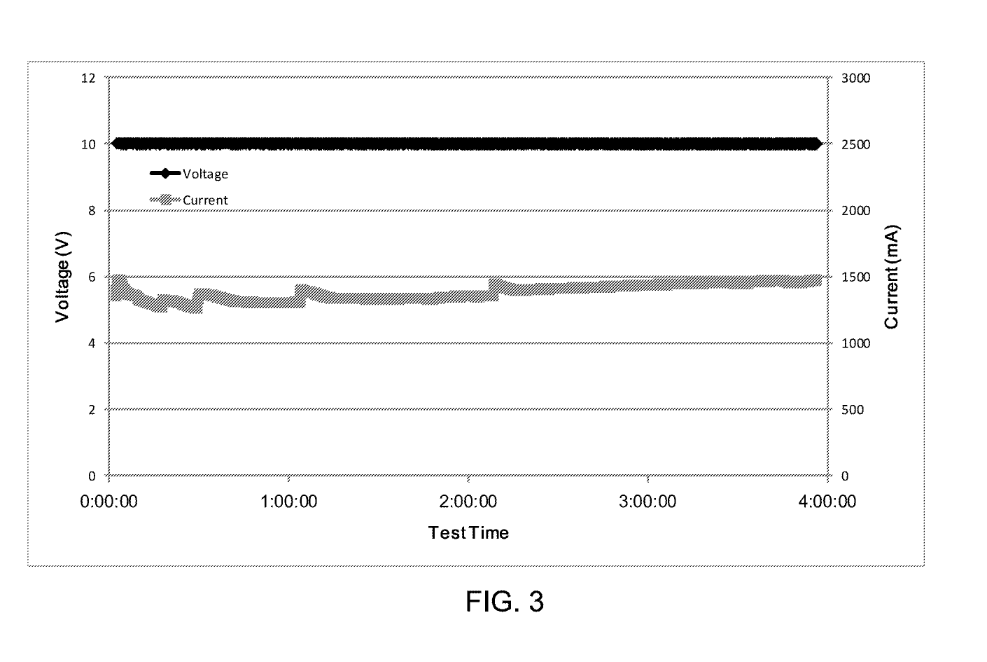

The voltage-current curves with respect to the test time are shown in FIG. 3. The electrical current shown in FIG. 3 maintained in a range of from about 1,300 mA to about 1,500 mA in about 4 hours, confirming the migration of the protons and the anions.

### Example 3

An aqueous stream of about 25 liters was obtained. The composition of the aqueous stream was analyzed using the inductive coupled plasma emission spectrometer and is listed in table 2 below.

TABLE 2

| element | Al | B | Ba | Bi | Ca | Co | Cr | Cu | Fe | K | Mg | Mn |
|---|---|---|---|---|---|---|---|---|---|---|---|---|
| Concentration | 0.63 | 0.23 | 0.09 | 0.09 | 85.8 | 0.49 | 56.8 | 0.47 | 398 | 5.1 | 29.5 | 1.6 |
| (ppm) | | | | | | | | | | | | |
| | | | | | | | | | | total P | total S | |
| element | Mo | Na | Ni | Pb | Si | Sr | V | Zn | Cl | as PO₄³⁻ | as SO₄²⁻ | — |
| Concentration | 0.37 | 28.8 | 18.7 | 0.07 | 11.8 | 0.61 | 0.23 | 1 | 41.8 | 1.3 | 4280 | — |
| (ppm) | | | | | | | | | | | | |

A recovery stream of about 1 liter was prepared and comprised 0.012% sulfuric acid. The pH of the recovery stream was about 2.6.

A constant DC voltage of 7 Volt was applied while the aqueous stream was recirculated through the first compartments and the recovery stream was recirculated through the second compartments both at a flow rate of about 0.21/min.

The concentration of acid was determined by titration with sodium hydroxide. The concentrations of other ionic species were measured using the inductive coupled plasma emission spectrometer and added up to be the concentration of impurities. The concentrations of acid and impurities in the aqueous stream and the recovery stream before and after about 4 hours of recirculation are listed in table 3 below.

TABLE 3

| | concentra- | concentra- | concentra- | concentra- |
|---|---|---|---|---|
| | tion | tion | tion | tion |
| | of acid | of acid | of impurities | of impurities |
| | before | after | before | after |
| stream | recirculation | recirculation | recirculation | recirculation |
| aqueous | 0.23 wt % | 0.05 wt % | 0.23 wt % | 0.22 wt % |
| recovery | 0.012 wt % | 2.44 wt % | 0 | 0.08 wt % |

The data in table 3 indicate that from the first compartments protons migrated through the proton selective membranes and anions migrated through the anion exchange membranes both to the second compartments while most of the cations other than protons were kept in the first compartments. Therefore, the acid was selectively recovered from the first compartments and concentrated in the second compartments. The acid recovery ratio was calculated with the following formula: the weight of acid in the recovery stream after 4 hours of recirculation/the weight of acid in the aqueous stream before 4 hours of recirculation×100% to be 75.9% and the purity of recovered acid was calculated with the following formula: the weight of acid in the recovery stream after 4 hours of recirculation/the weight of the recovery stream after 4 hours of recirculation×100% to be 96.7 wt %.

### Example 4

An aqueous stream of about 25 liters was obtained. The composition of the aqueous stream was analyzed using the inductive coupled plasma emission spectrometer and is listed in table 4 below. Besides, 219.8 ppm of F⁻ and 676.6 ppm of NO₃⁻ were detected by an ion chromatography.

TABLE 4

| element | Al | B | Ba | Bi | Ca | Co | Cr | Cu | Fe | K | Mg | Mn |
|---|---|---|---|---|---|---|---|---|---|---|---|---|
| Concentration | 0.65 | 0.27 | 0.02 | 0.15 | 66.6 | 1.2 | 61.4 | 1.2 | 445 | 1.9 | 11 | 3.5 |
| (ppm) | | | | | | | | | | | | |
| | | | | | | | | | | total P | total S | |
| element | Mo | Na | Ni | Pb | Si | Sr | V | Zn | Cl | as PO₄³⁻ | as SO₄²⁻ | — |
| Concentration | 0.82 | 24.1 | 54.9 | 0.1 | 7.5 | 0.24 | 0.21 | 1.1 | 112 | 2.7 | 2234 | — |
| (ppm) | | | | | | | | | | | | |

A recovery stream of about 1 liter was prepared and comprised 0.012 wt % sulfuric acid. The pH of the recovery stream was about 6.03.

A constant DC voltage of 7 Volt was applied to the cathode and the anode while the aqueous stream was recirculated through the first compartments and the recovery stream was recirculated through the second compartments both at a flow rate of 0.2 l/min.

The concentration of acid was determined by titration with sodium hydroxide. The concentrations of other ionic species were measured using the inductive coupled plasma emission spectrometer and added up to be the concentration of impurities. The concentrations of acid and impurities in the aqueous stream and the recovery stream before and after about 4 hours of recirculation are listed in table 5 below.

TABLE 5

| | concentra- | concentra- | concentra- | concentra- |
|---|---|---|---|---|
| | tion | tion | tion | tion |
| | of acid | of acid | of impurities | of impurities |
| | before | after | before | after |
| stream | recirculation | recirculation | recirculation | recirculation |
| aqueous | 0.15 wt % | 0.05 wt % | 0.23 wt % | 0.21 wt % |
| recovery | 0.012 wt % | 1.97 wt % | 0 | 0.11 wt % |

The data in table 4 indicate that from the first compartments mainly protons migrated through the proton selective membranes and anions migrated through the anion exchange membranes both to the second compartments while most of the cations other than protons were kept in the first compartments. Therefore, the acid was selectively recovered from the first compartments and concentrated in the second compartments. The acid recovery ratio was calculated with the following formula: the weight of acid in the recovery stream after 4 hours of recirculation/the weight of acid in the aqueous stream before 4 hours of recirculation×100% to be 68.4% and the purity of recovered acid was calculated with the following formula: the weight of acid in the recovery stream after 4 hours of recirculation/the weight of the recovery stream after 4 hours of recirculation×100% to be 94.4 wt %.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

What is claimed is:

1. An apparatus for recovering acid, comprising:
a cathode;
an anode;
a plurality of anion exchange membranes disposed between the cathode and the anode;
a plurality of proton selective membranes alternately arranged with the plurality of anion exchange membranes;
a plurality of first compartments for accommodating an aqueous stream comprising anions and protons; and
a plurality of second compartments alternately arranged with the plurality of first compartments for accommodating a recovery stream receiving from the first compartments anions through the anion exchange membranes and mainly protons through the proton selective membranes to recover acid from the aqueous stream.

2. The apparatus of claim 1, wherein the proton selective membrane comprises an anion exchange membrane element and a cation exchange membrane element attached to the anion exchange membrane element.

3. The apparatus of claim 2, wherein the anion exchange membrane element faces the anode and the cation exchange membrane element faces the cathode.

4. The apparatus of claim 1, wherein the proton selective membrane comprises a layer of anion exchange material and a layer of cation exchange material integrated with the layer of anion exchange material.

5. The apparatus of claim 4, wherein the layer of anion exchange material faces the anode and the layer of cation exchange material faces the cathode.

6. The apparatus of claim 1, wherein the aqueous stream comprises cations other than protons.

7. A method for recovering acid, comprising:
inputting an aqueous stream comprising anions and protons into an apparatus, the apparatus comprising a cathode, an anode, a plurality of anion exchange membranes disposed between the cathode and the anode, a plurality of proton selective membranes alternately arranged with the plurality of anion exchange membranes, a plurality of first compartments for receiving the aqueous stream, and a plurality of second compartments alternately arranged with the plurality of first compartments; and
applying a voltage to the cathode and the anode to migrate from the first compartments the anions through the anion exchange membranes and mainly protons through the proton selective membranes to a recovery stream in the second compartments.

8. The method of claim 7, comprising: recirculating the aqueous stream through the first compartments.

9. The method of claim 7, comprising: providing the recovery stream to the second compartments before applying the voltage.

10. The method of claim 7, wherein the proton selective membrane comprises an anion exchange membrane element and a cation exchange membrane element attached to the anion exchange membrane element.

11. The method of claim 7, wherein the proton selective membrane comprises a layer of anion exchange material and a layer of cation exchange material integrated with the layer of anion exchange material.

12. The method of claim 7, wherein the aqueous stream comprises cations other than protons.

13. The method of claim 7, wherein the acid comprises hydrogen chloride.

14. The method of claim 7, wherein the acid comprises hydrogen chloride, hydrogen fluoride, sulfuric acid, nitric acid, phosphoric acid, or any combination thereof.

15. The method of claim 7, wherein the acid comprises hydrogen chloride, phosphoric acid, sulfuric acid or any combination thereof.

16. The method of claim 7, wherein the voltage is in a range of from about 0.5 Volt to about 3.0 Volt for each first compartment and one adjacent second compartment.

17. The method of claim 7, comprising: recirculating the recovery stream through the second compartments.

18. The method of claim 7, wherein the recovery stream comprises an aqueous solution of the acid.

19. The method of claim 7, wherein a final acid concentration in the recovery stream is from about 2 times to about 20 times of an initial acid concentration of the aqueous stream.

20. The method of claim 7, wherein a ratio of a final amount of acid in the recovery stream to an initial amount of acid in the aqueous stream is in a range of from about 50% to about 90%.
